(19) United States
(12) Patent Application Publication
(10) Pub. No.: US 2013/0051895 A1
(43) Pub. Date: Feb. 28, 2013

(54) TIP OF WRITING IMPLEMENT

(71) Applicant: CHUNG-CHI CHOU, New Taipei City (TW)

(72) Inventor: CHUNG-CHI CHOU, New Taipei City (TW)

(21) Appl. No.: 13/219,719

(22) Filed: Aug. 29, 2011

(51) Int. Cl. B43K 8/00

(52) U.S. Cl. 401/196

(57) ABSTRACT

Provided is an improved shape of writing tip of writing implement. The writing tip is connectable to a barrel of the writing implement. The writing tip includes a head section that allows a user to draw at least one line of different widths. The writing tip also forms, at an end distant from the head section, a connection section that is connectable with the barrel. The head section forms a plurality of contact sections. As such, a user may draw at least one line of different widths and/or one or more than two lines.

### (a) TECHNICAL FIELD OF THE INVENTION

The present invention generally relates to a tip of writing implement, and more particularly to a writing tip that can draw at least one line of variable thickness or one or more than two lines.

### (b) DESCRIPTION OF THE PRIOR ART

Referring to FIGS. 1 and 2, which are schematic views illustrating a conventional marker pen, generally designated at 3. The conventional marker pen 3 is generally composed of a felt like fibrous writing tip 30 and a tubular barrel 31 to which the writing tip 30 is coupled. The writing tip 30 comprises a liquid-absorbable wick-like core that extends into an interior chamber that contains ink. The ink contains a color pigment.

In the operation, to the ink is supplied to the writing tip 30 in such a way that the ink 30 is driven by capillary from the chamber to the writing tip 30.

Such a conventional marker pen 3 is well known and is widely used to for example mark an article by showing coloring result on paper.

However, such a conventional marker pen 3 suffers the following drawbacks and disadvantages to be solved and improved:

(1) The writing tip 30 of the conventional marker pen 3 is generally manufactured in the shape of a chisel or a bullet form. This makes the shape monotonous and does not appeal to and move the general consumers for purchasing.

(2) The conventional marker pen 3 can only draw a single line each time and cannot give any incentive or excitation for a user to make writing creation.

Thus, it is a major challenge of the industry to overcome or alleviate the above discussed drawbacks and deficiencies.

### SUMMARY OF THE INVENTION

In view of the above described drawbacks and deficiencies of the conventional marker pens, the present invention aims to provide an improved shape of writing tip of writing implement that allows of drawing of lines of different widths and one or more than two lines.

The primary objective of the present invention is to provide different styles and shapes of head section of the writing tip so that a user may use the head section to draw at least one line of variable thickness or different widths and/or to draw one or more than two lines.

To achieve the above objective, the present invention provides an improved shape of writing tip of writing implement, wherein the writing tip is connectable to a barrel of the writing implement. The writing tip comprises a head section that allows a user to draw at least one line of different widths. The writing tip also forms, at an end distant from the head section, a connection section that is connectable with the barrel. The head section forms a plurality of contact sections for drawing more than two lines. The contact sections are formed in different styles and shapes.

With the above described arrangement, a user may uses the various styles and shapes of the head section and the contact sections to draw at least one line of different widths and/or one or more than two lines, whereby a user, when making writings, is provided with different and various senses and inspirations of writing creation. As such, the drawbacks and deficiencies of the conventional marker pens that does not allow the user to draw lines of richness and that does not stimulate the desire of purchase of general consumers can be overcome or at least alleviated by the present invention. Consequently, the present invention realizes a practical improvement.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional marker pen.

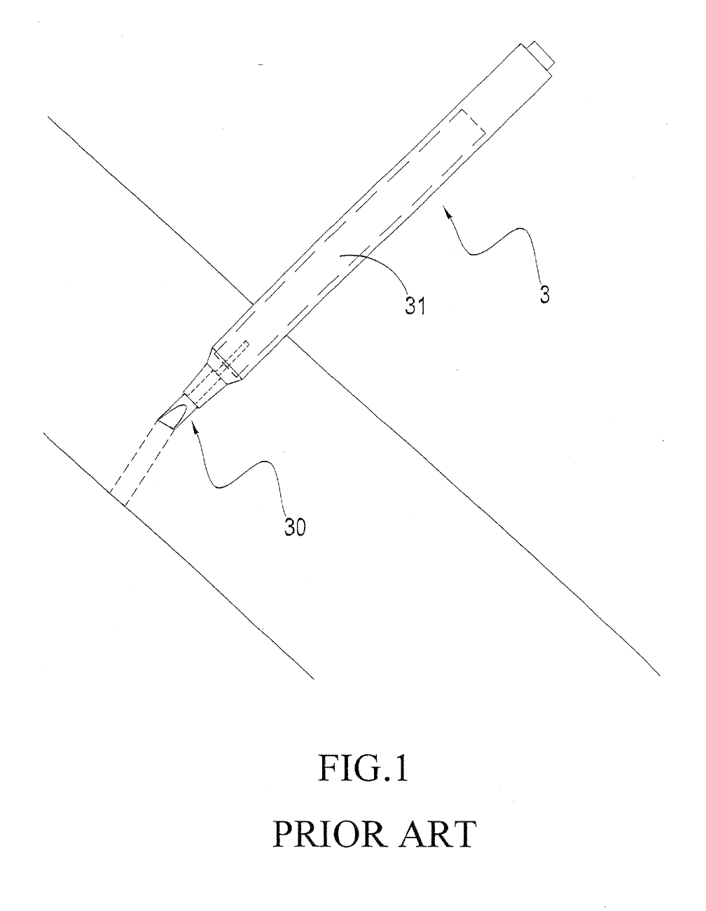

FIG. 2 is another schematic view showing the conventional marker pen.

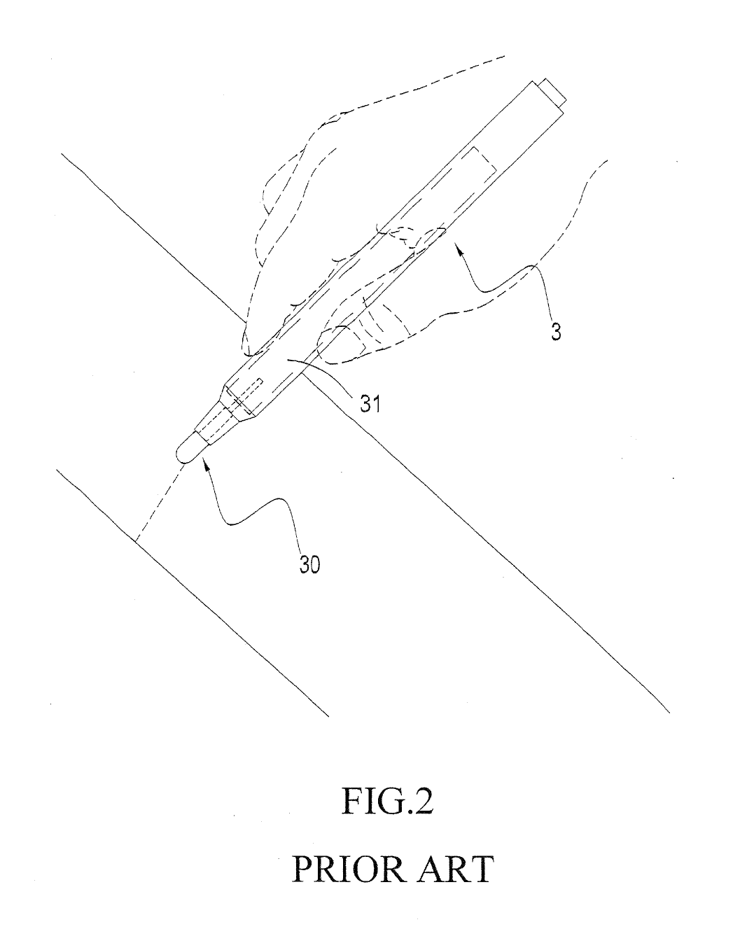

FIG. 3 is a schematic view illustrating a writing tip constructed in accordance with a preferred embodiment of the present invention.

FIG. 4 is a schematic view illustrating an application of use of the preferred embodiment of the present invention.

FIG. 5 is a schematic view illustrating an application of use of the preferred embodiment of the present invention.

FIG. 6 is a schematic view illustrating an application of use of the preferred embodiment of the present invention.

FIG. 7 is a schematic view illustrating an application of use of the preferred embodiment of the present invention.

FIG. 8 is a schematic view illustrating an application of use of the preferred embodiment of the present invention.

FIG. 9 is a schematic view illustrating an application of use of the preferred embodiment of the present invention.

FIG. 10 is a schematic view illustrating an application of use of the preferred embodiment of the present invention.

FIG. 11 is a schematic view illustrating an application of use of the preferred embodiment of the present invention.

FIG. 12 is a schematic view illustrating an application of use of the preferred embodiment of the present invention

FIG. 13 is a schematic view illustrating an application of use of the preferred embodiment of the present invention.

FIG. 14 is a schematic view illustrating an application of use of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

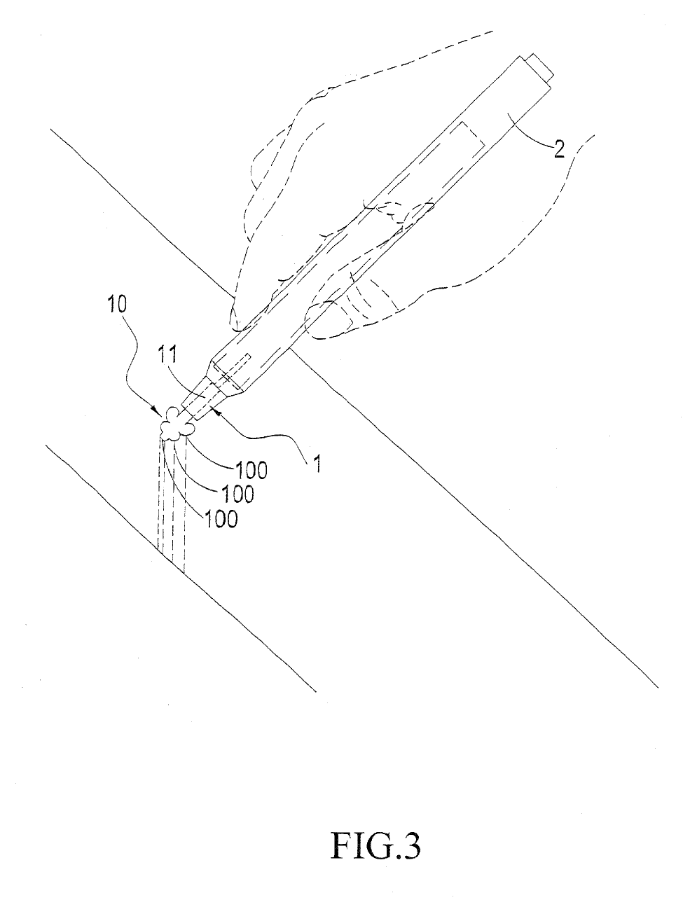

With reference to the drawings and in particular to FIG. 3, which illustrates a writing tip constructed in accordance with an embodiment of the present invention, the writing tip, which is generally designated at 1, is coupled to a barrel 2.

The writing tip 1 comprises a head section 10 that allows a user to draw at least one line of different widths. The writing tip 1 also forms, at an end distant from the head section 10, a connection section 11 that is connectable with the barrel 2. The head section 10 forms a plurality of contact sections 100 for drawing more than two lines. The contact sections 100 are formed on the head section 10 to be selectively put into contact with predetermined locations on a piece of paper. The contact sections 100 can be made in the shape of an arrow, a calabash, a heart, a butterfly, or a knife.

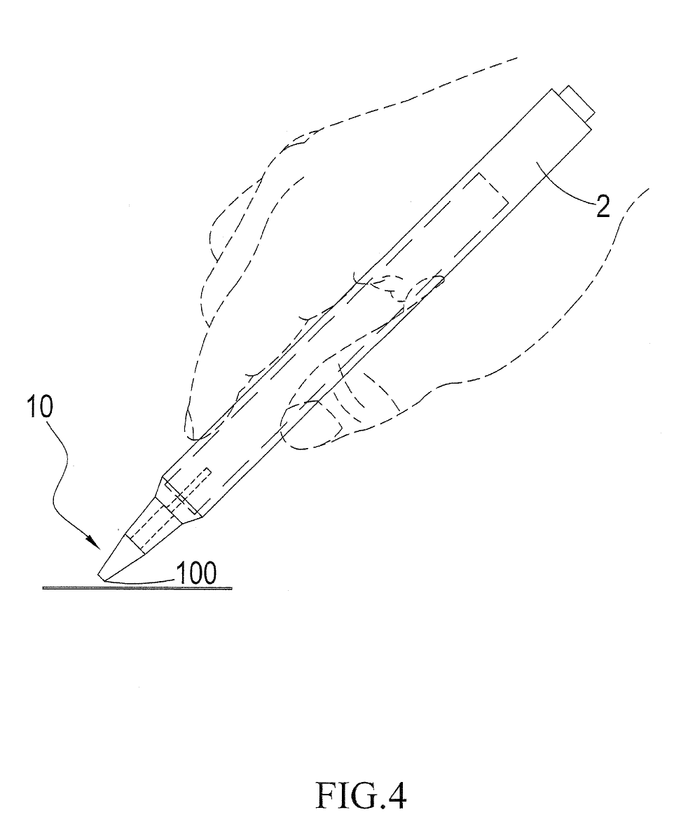

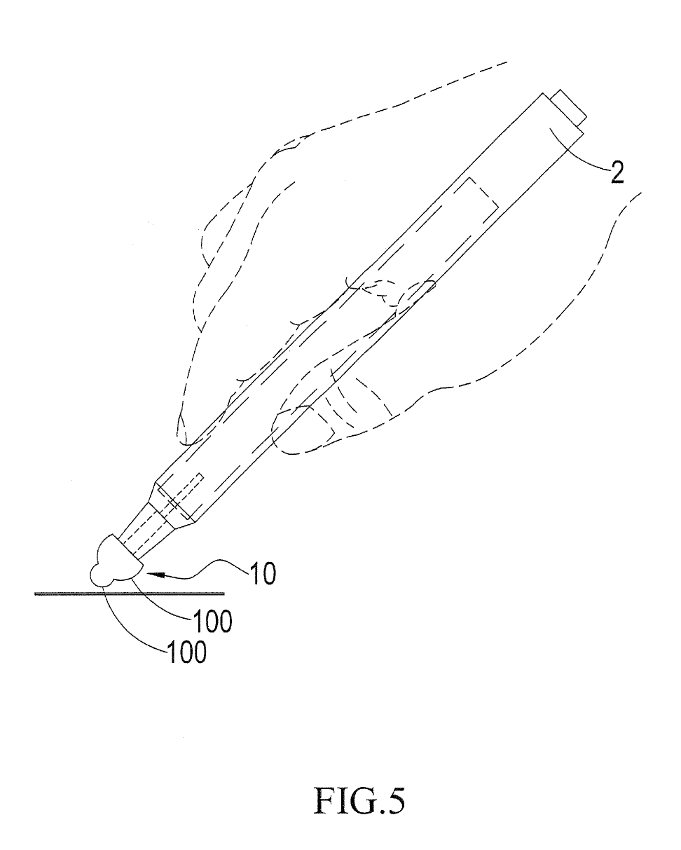

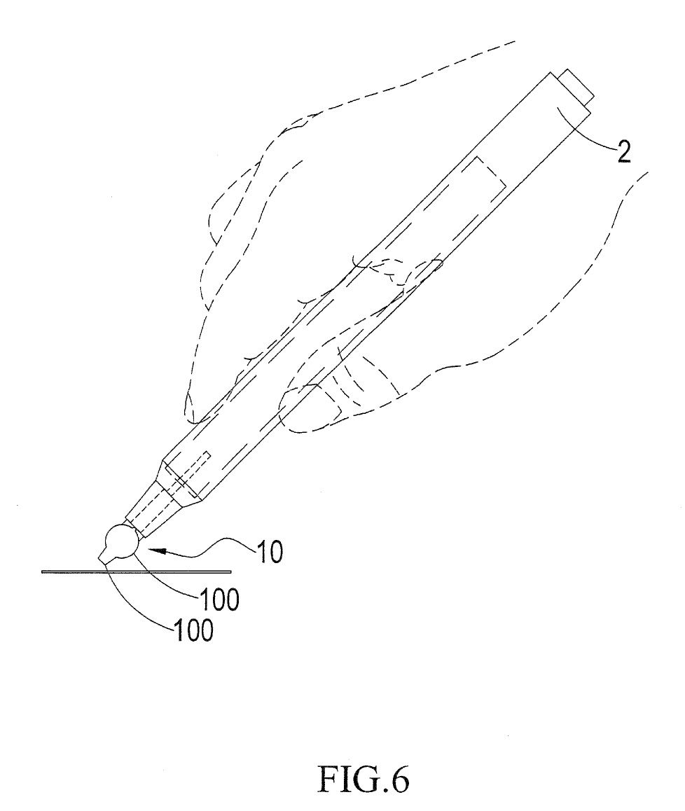

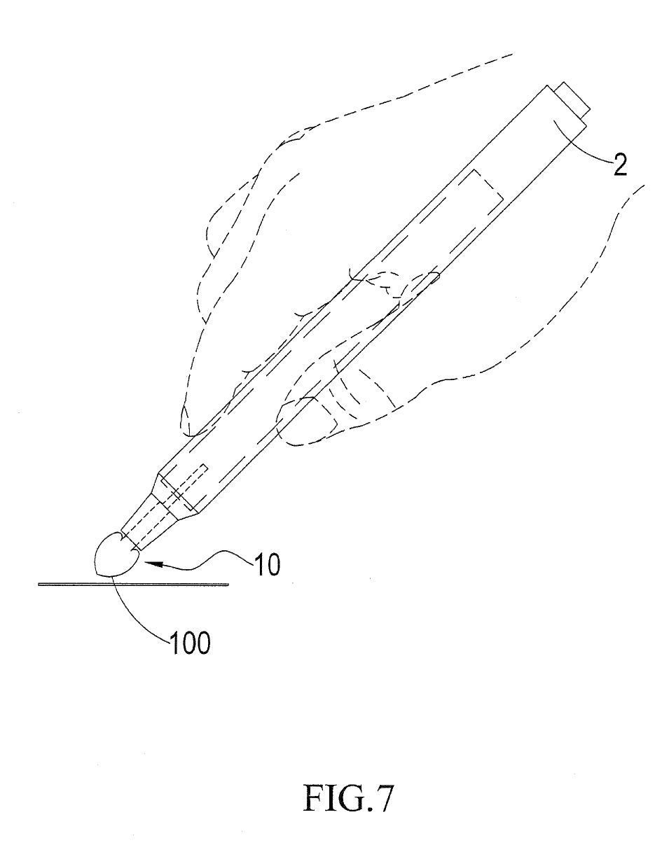

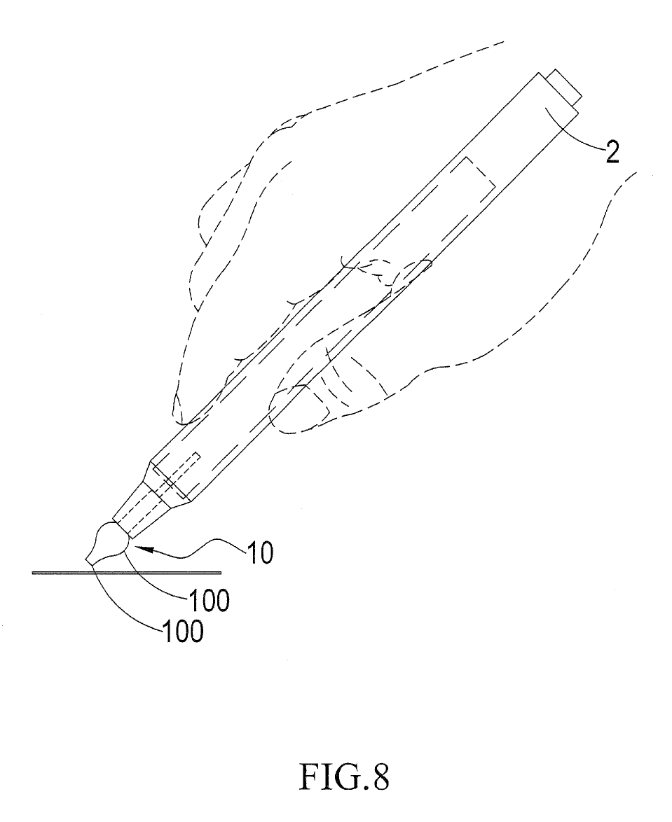

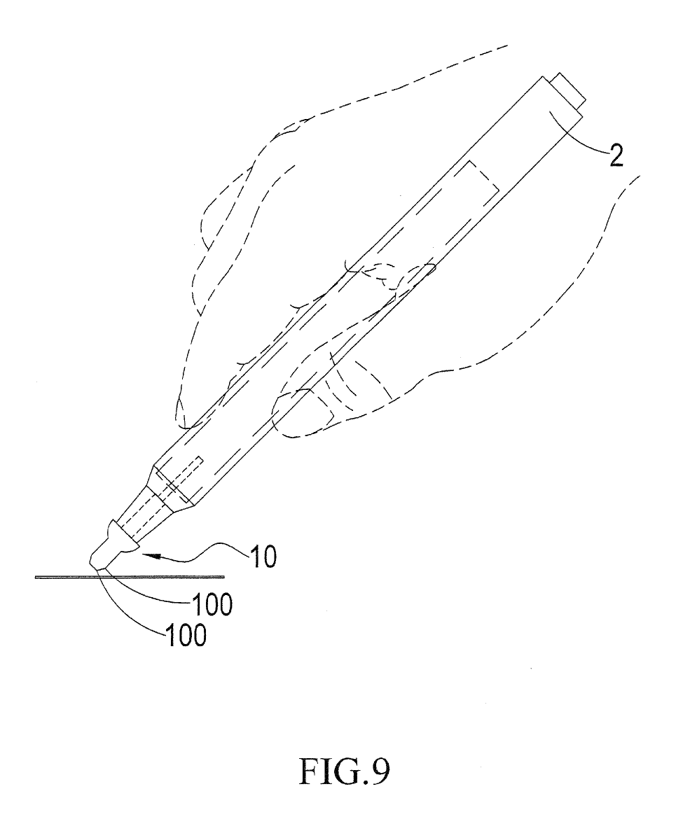

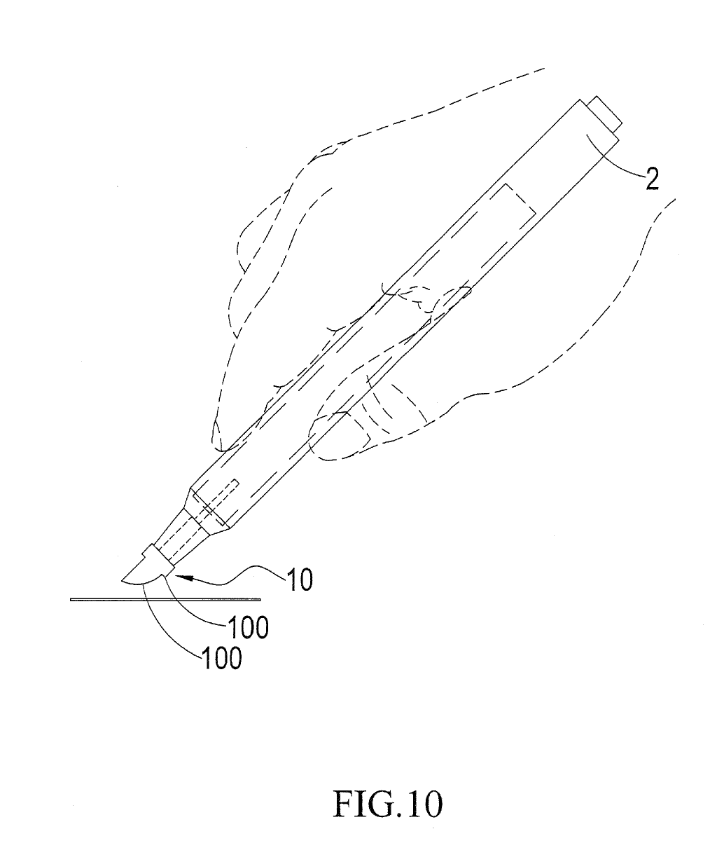

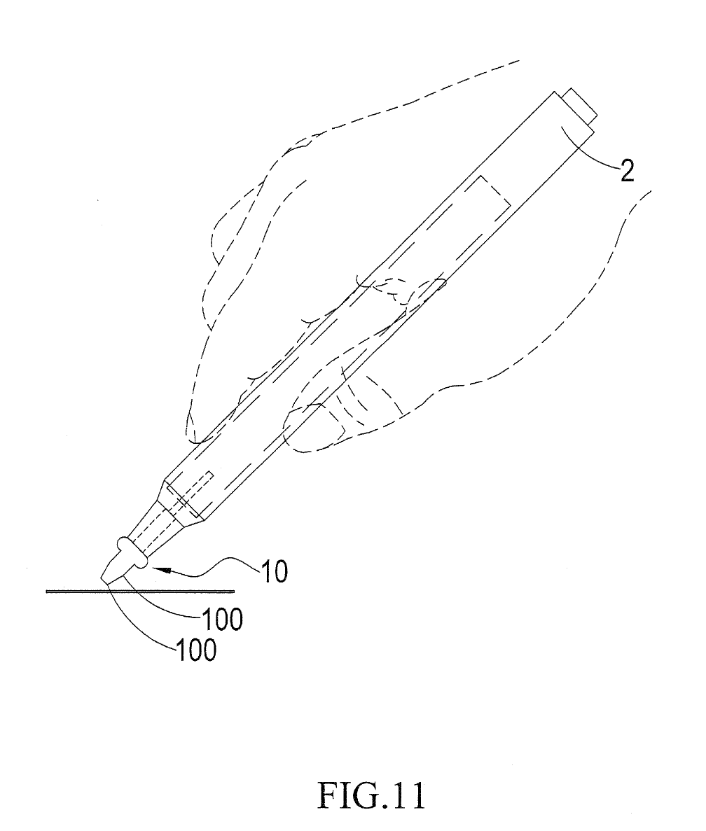

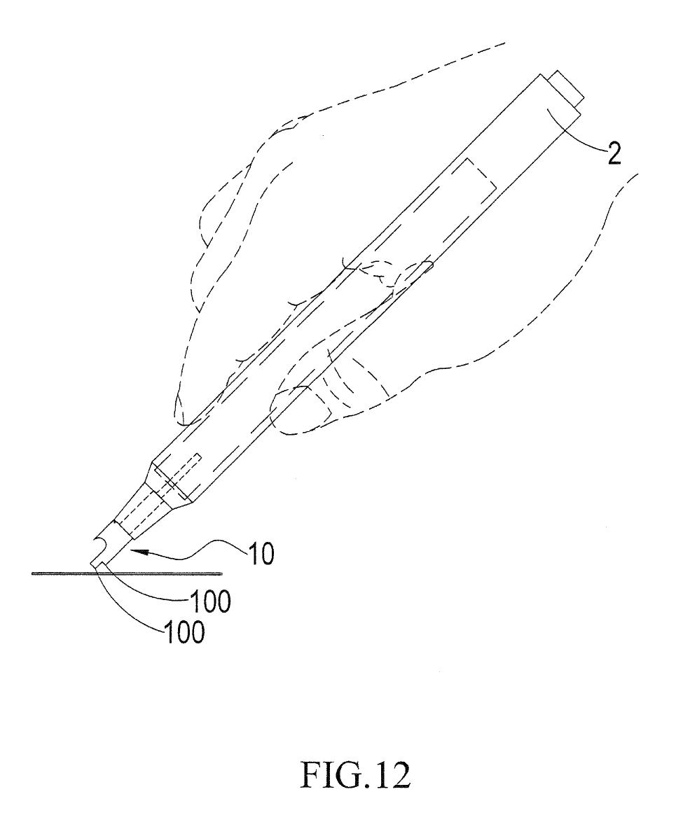

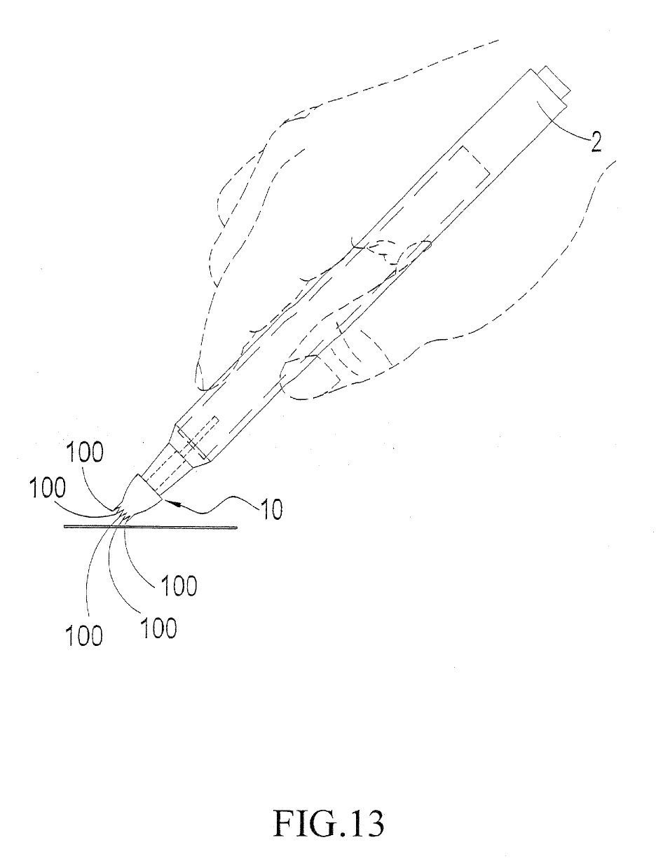

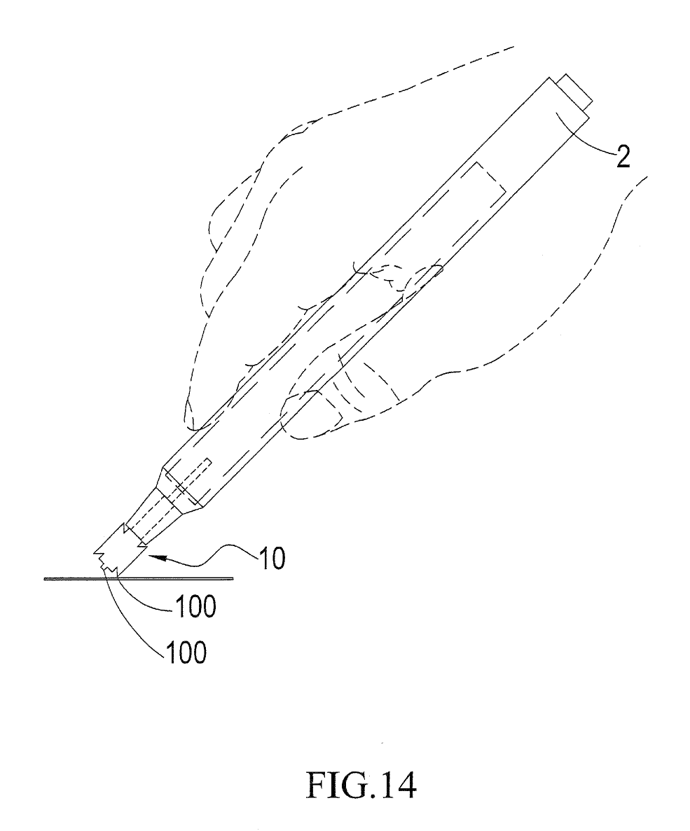

Referring to FIGS. 4-14, various applications of the embodiments of the present invention are illustrated. These drawings clearly show that the present invention can be embodied to have variably shaped head sections 10. The present invention takes advantage of the variable shapes of the head section 10 to attract the general consumers and to simulate the general consumers' desire of purchase. When a user purchases and owns a set of stationery containing the present invention, the user may remove a cap of the pen to expose the head section 10. The user may hold the barrel 2 to bring the head section 10 toward a predetermined location on a piece of paper. By putting the head section 10 in contact with the paper and moving the pen in a predetermined direction, at least one line can be drawn. The user may replace different styles or shapes of contact section 100 to draw lines of different widths, making different senses of aesthetics of lines.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tip of writing implement, which is adapted to be coupled to a barrel, the tip comprising:
a head section that is adapted to draw at least one line of different widths, the head section being formed at one end of the tip; and
a connection section, which is formed at an end of the tip that is distant from the head section and is connectable to the barrel.

2. The tip of writing implement according to claim 1, wherein the head section forms a plurality of contact sections.

3. The tip of writing implement according to claim 2, wherein the contact sections are formed to draw more than two lines.

4. The tip of writing implement according to claim 1, wherein the head section is made in various styles and shapes.

5. The tip of writing implement according to claim 2, wherein the contact sections are formed on the head section and are selectively put into contact with predetermined locations of a piece of paper.

6. The tip of writing implement according to claim 1, wherein the head section is made in the shape of one of an arrow, a calabash, a heart, a butterfly, and a knife.
